(19) United States
(12) Patent Application Publication
(10) Pub. No.: US 2013/0042735 A1
(43) Pub. Date: Feb. 21, 2013

(54) METHOD OF CUTTING A MOTHER SUBSTRATE [as amended]

(71) Applicants: Sang-Hyung LIM, Yongin-City (KR); Jang-Hwan SHIN, Yongin-City (KR)

(72) Inventors: Sang-Hyung LIM, Yongin-City (KR); Jang-Hwan SHIN, Yongin-City (KR)

(21) Appl. No.: 13/661,487

(22) Filed: Oct. 26, 2012

Related U.S. Application Data
(62) Division of application No. 12/458,527, filed on Jul. 15, 2009.

(30) Foreign Application Priority Data
Jul. 16, 2008 (KR) 10-2008-0069174

(51) Int. Cl. B26D 1/15

(52) U.S. Cl. 83/56

(57) ABSTRACT

A mother substrate cutting apparatus which may include a stationary stage, a moving stage on the stationary stage, the moving stage being configured to move in a first direction, a guide bar on the stationary stage, the guide bar being connected to the stationary stage via posts and configured to extend above the moving stage in a second direction crossing the first direction, a moving unit at the guide bar, the moving unit being configured to move on the guide bar, a lifter on the moving unit, the lifter being configured to move in a third direction that crosses the first direction and the second direction, and a blade on the lifter, the blade being configured to rotate and cut the mother substrate on the moving stage.

### CROSS REFERENCE TO RELATED APPLICATION

This is a divisional application based on pending application Ser. No. 12/458,527, filed Jul. 15, 2009, the entire contents of which is hereby incorporated by reference.

### BACKGROUND OF THE INVENTION

1. Field of the Invention

Embodiments relate to a mother substrate cutting apparatus and an organic light emitting diode (OLED) display. More particularly, the embodiments relate to a mother substrate cutting apparatus capable of cutting a thin mother substrate while securing quality of an incision surface, a method of cutting a mother substrate using the same, and an OLED display cut thereby.

2. Description of the Related Art

An OLED display includes an OLED that has a hole injection electrode, an organic emission layer, and an electron injection electrode. The OLED display emits light by energy generated when excitons are dropped from an exited state to a ground state after the excitons are generated by coupling electrons and holes in the organic emission layer.

The OLED display includes subpixels arranged in a matrix at a display area and a driving circuit unit. Each subpixel includes an organic light emitting element and a driving circuit unit. The driving circuit unit includes a switching transistor, a driving transistor, and a storage capacitor. The OLED display is formed by forming subpixels at a rear substrate and sealing the rear substrate to the front substrate.

Although the OLED display may be manufactured individually as one cell, a plurality of the OLED displays may be manufactured using a mother substrate to improve productivity. That is, the mother substrate is an intermediate product formed during a manufacturing process of the OLED displays. The mother substrate includes a plurality of cells of OLED displays.

Therefore, it is required to cut the mother substrate into cells, i.e., separate the plurality of OLED displays into individual OLED cells, using a cutting apparatus to produce a final product.

A conventional cutting apparatus for mother substrates may be a wheel scriber. In this case, a wheel scriber may be used to form a crack on a surface of the mother substrate, and then, a predetermined force may be applied in a vertical direction with respect to the surface onto the crack to cut the mother substrate into cells.

However, it may be more difficult to form cracks on the surface of the mother substrate and to separate the cells, i.e., the OLED displays, as the thickness of the mother substrate is reduced. It may be also difficult to secure quality of the incision surface because the cracks may remain on the incision surface of the OLED display.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a mother substrate cutting apparatus capable of cutting a thin mother substrate.

It is therefore a feature of an embodiment to provide a mother substrate cutting apparatus capable of securing quality of an incision surface by preventing a formation of crack on the surface of mother substrate.

At least one of the above features and other advantages may be realized by providing a mother substrate cutting apparatus which may include a stationary stage, a moving stage on the stationary stage, the moving stage being configured to move in a first direction, a guide bar on the stationary stage, the guide bar being connected to the stationary stage via posts and configured to extend above the moving stage in a second direction crossing the first direction, a moving unit at the guide bar, the moving unit being configured to move on the guide bar, a lifter on the moving unit, the lifter being configured to move in a third direction that crosses the first direction and the second direction, and a blade on the lifter, the blade being configured to rotate and cut the mother substrate on the moving stage.

The stationary stage may include a guide that extends in the first direction, the guide being coupled to a guide groove in the moving stage.

The stationary stage may include a lead screw that extends in the first direction at a side of the moving stage, the lead screw having a rotation motion and being coupled to screw groove in the moving stage.

The moving unit may be a linear motor configured to make a linear motion along the guide bar.

The lifter may be a cylinder on the linear motor.

The blade may be connected to a motor attached to the lifter. The blade may include a dicing saw.

The mother substrate may include a first protection film and a second protection film attached at opposite sides of the mother substrate.

The moving stage may include an absorptive jig, the absorptive jig having a groove corresponding to an edge of the blade.

The blade may be a rotary blade. A length of the blade is longer than a thickness of the mother substrate, the length and the thickness being measured along the third direction.

Each of a rear substrate and a front substrate of the mother substrate has a thickness of about 0.125 mm to about 0.3 mm.

At least one of the above features and other advantages of the present invention may be realized by providing an organic light emitting diode (OLED) display including a rear substrate and a front substrate sealed together, the rear substrate and the front substrate including substantially smooth incision surfaces that contain a stripe pattern, and subpixels arranged between the rear substrate and the front substrate, each subpixels having an organic light emitting element and a driving circuit unit, wherein.

At least one of the above features and other advantages of the present invention may be realized by providing a method of cutting the mother substrate into stripes by positioning the mother substrate on a moving stage of a stationary stage, positioning a blade at a cutting position above the mother substrate through controlling a moving unit disposed at a guide bar and a lifter disposed at the moving unit, the blade contacting the mother substrate, moving the moving stage in the first direction and rotating the blade to cut the mother substrate.

Cutting the mother substrate may include cutting the mother substrate into stripes and cutting the stripes into cells.

The stripes may be cut using the full-cutting and the cells may be cut using the half-cutting.

Both the stripes and the cells may be cut via full-cutting.

Cutting into stripes may include repeatedly driving the moving unit, the lifter and the moving stage.

Cutting the mother substrate may include cutting an incision surface of the mother substrate into a stripe pattern by a rotary operation of the blade, such that a cell is defined between at least two stripes.

The cell may form an OLED display.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective view of a mother substrate cutting apparatus according to an exemplary embodiment of the present invention.

FIG. 2 illustrates a schematic diagram of a subpixel circuit structure of an OLED display on a mother substrate of FIG. 1 as a cell.

FIG. 3 illustrates a partial enlarged cross-sectional view of an OLED display on a mother substrate of FIG. 1 as a cell.

FIG. 4 illustrates a side view of a mother substrate of FIG. 1.

FIG. 5 illustrates a diagram of cutting a mother substrate using the mother substrate cutting apparatus of FIG. 1 and a cutting method according to the first exemplary embodiment.

FIG. 6 illustrates a cross-sectional view of cutting a mother substrate to a stripe using a mother substrate cutting apparatus of FIG. 1.

FIG. 7 illustrates a top plan view of a mother substrate cut into stripes by a mother substrate cutting apparatus of FIG. 1.

FIG. 8 illustrates a top plan view of a stripe of FIG. 7 cut into cells.

FIG. 9 illustrates a cross-sectional view of a cut made on a mother substrate using a wheel scriber according to a comparative art.

FIG. 10 illustrates a cross-sectional view of a cut made on a mother substrate using a mother substrate cutting apparatus of FIG. 1.

FIG. 11 illustrates a partial enlarged view of FIG. 10.

FIG. 12 illustrates a diagram of cutting a mother substrate using a mother substrate cutting apparatus and a cutting method according to another exemplary embodiment of the present invention.

FIG. 13 through FIG. 15 illustrate cross-sectional views of cuts made on various mother substrates having different thicknesses.

FIG. 16 illustrates a cross-sectional view of a half-cutting state of a mother substrate cutting apparatus of the present invention.

### DETAILED DESCRIPTION OF THE INVENTION

Korean Patent Application No. 10-2008-0069174, filed on Jul. 16, 2008, in the Korean Intellectual Property Office, and entitled: “Mother Substrate Cutting Apparatus and Organic Light Emitting Diode Display Cut Thereby,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

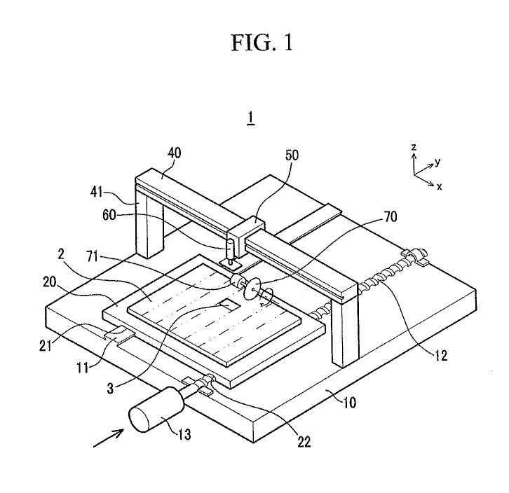

FIG. 1 illustrates a perspective view of a mother substrate cutting apparatus according to an exemplary embodiment of the present invention. Referring to FIG. 1, the mother substrate cutting apparatus 1 according to an exemplary embodiment may include a stationary stage 10, a moving stage 20, a guide bar 40, a moving unit 50, a lifter 60, and a blade 70.

A mother substrate 2 may have a plurality of cells, each cell corresponding to one OLED display 3. The mother substrate cutting apparatus 1 may cut the mother substrate 2 into cells, i.e., a plurality of OLED displays 3. Hereinafter, an OLED display 3 corresponding to, e.g., formed as, one cell will be described.

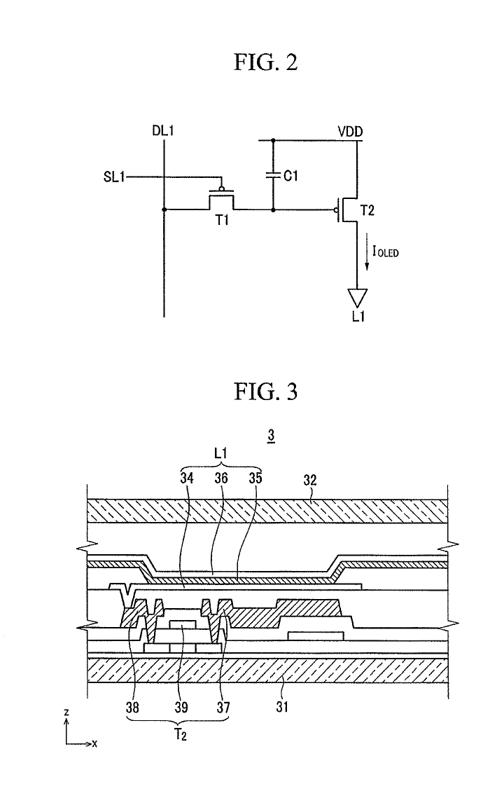

FIG. 2 illustrates a schematic diagram of a subpixel circuit structure of an OLED display that is formed on a mother substrate of FIG. 1 as a cell. FIG. 3 illustrates a partial enlarged cross-sectional view of an OLED display on a mother substrate of FIG. 1 as a cell.

Referring to FIGS. 2 and 3, the OLED display 3 may include a rear substrate 31, a front substrate 32 facing the rear substrate 31, and subpixels (not shown) disposed at display areas between the rear and front substrates 31 and 32 in a matrix format.

In the OLED display 3, each of the subpixels may include an organic light emitting element L1 and a driving circuit unit. The organic light emitting element L1 may include an anode 34, an organic emission layer 35, and a cathode 36.

The driving circuit unit may include at least two thin film transistors and at least one storage capacitor C1. The two thin film transistors may include a switching transistor T1 and a driving transistor T2.

The switching transistor T1 may be connected to a scan line SL1 and a data line DL1, and may transmit a data voltage from the data line DL1 to the driving transistor T2 according to a switching voltage input to the scan line SL1.

The storage capacitor C1 may be connected to the switching transistor T1 and to a power line VDD. The storage capacitor C1 may store a voltage corresponding to a voltage difference between a voltage transmitted from the switching transistor T1 and a voltage supplied from the power line VDD.

The driving transistor T2 may be connected to the power line VDD and the storage capacitor C1. The driving transistor T2 may apply an output current (I_{OLED}) in proportion to the square of a voltage difference between a voltage stored in the storage capacitor C1 and a threshold voltage. The organic light emitting element L1 may emit light by the output current (I_{OLED}).

The driving transistor T2, as illustrated in FIG. 3, may include a source electrode 37, a drain electrode 38, and a gate electrode 39. The anode 34 of the organic light emitting element L1 may be connected to the drain electrode 38 of the driving transistor T2. The configuration of the subpixel, however, may not be limited to the above-mentioned configuration, and can be variously modified.

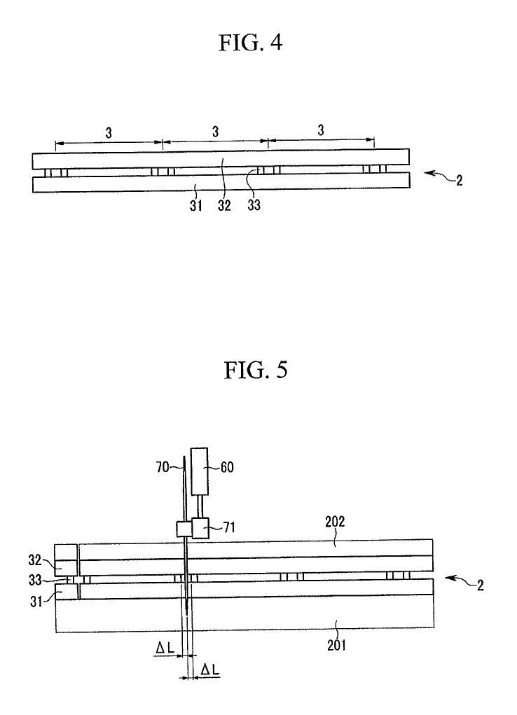

FIG. 4 illustrates a side view of a mother substrate of FIG. 1. Referring to FIG. 4, the mother substrate 2 may include a plurality of OLED displays 3 between the rear substrate 31 and the front substrate 32. The mother substrate 2 may further include a sealant 33 separately formed between adjacent OLED displays 3. The front substrate 32 may be sealed with the rear substrate 31 by the sealant 33 at predetermined intervals. For example, one sealant 33 may be at each edge of an individual OLED display 3, as will be discussed in more detail with respect to FIG. 5. Therefore, the sealing of each OLED display 3 may be sustained even when the mother substrate 2 is cut. Further, the driving circuit units, e.g., the thin film transistor T2, and the organic light emitting elements L1 formed on the rear substrate 31 may be protected from the outside.

Referring to FIG. 1 again, the stationary stage 10 may provide a xy plane in the mother substrate cutting apparatus 1 according to an exemplary embodiment. The moving stage 20 may provide a movable structure in the first direction, e.g., y-axis direction, on the xy plane of the stationary stage 10 and also may form a xy plane that supports the mother substrate 2.

The moving stage 20 may support the mother substrate 2, and may move the mother substrate 2 in the y-axis direction when the mother substrate 2 is being cut using the blade 70. The moving stage 20 may include an additional unit (not shown) to fasten the mother substrate 2.

The stationary stage 10 and the moving stage 20 may be joined in a structure that limits the movement in the second direction, e.g., x-axis direction, and the third direction, e.g., z-axis direction, to enable the moving stage 20 to stably move in the y-axis direction, e.g., only in the y-axis direction, on the stationary stage 10.

The stationary stage 10 may include a guide 11 protruding from a top surface thereof, i.e., a surface facing the moving stage 20, and extending in the y-axis direction. The moving stage 20 may include a guide groove 21 formed in the y-axis direction and connected to the guide 11. For example, the guide 11 may fit into the guide groove 21.

For the moving stage 20 to have a driving force to move, the stationary stage 10 may include a lead screw 12, and the moving stage 20 may include a screw groove 22. The stationary stage 10 and the moving stage 20 may be coupled through the lead screw 12 and the screw groove 22.

The lead screw 12 may be formed on the stationary stage 10 facing the moving stage 20 and may extend in the y-axis direction. The lead screw 12 may rotate in the stationary stage 10. The screw groove 22 may be formed in the moving stage 20 and may be coupled to the lead screw 12.

A motor 13 may be connected at one side of the lead screw 12. The lead screw 12 may rotate according to the operation of the motor 13. According to the rotation of the lead screw 12, the moving stage 20 coupled to the lead screw 12 through the screw groove 22 may move forward or backward in the y-axis direction on the stationary stage 10.

The guide bar 40 may be disposed above the moving stage 20 across the moving stage 20 in the x-axis direction. The guide bar 40 may be mounted on posts 41 formed on the stationary stage 10 in the z-axis direction, thereby maintaining a predetermined gap from the moving stage 20 and the mother substrate 2 placed thereon. The guide bar 40 may provide a moving path in the x-axis direction to the blade 70 while cutting the mother substrate 2.

The moving unit 50 may be disposed at the guide bar 40 and may move the blade 70 in the x-axis direction along the guide bar 40. For example, the moving unit 50 may be manufactured as a linear motor that makes a linear movement along the guide bar 40. For example, the moving unit 50 may slide along the guide bar 40 in the x-direction, so that the blade 70 attached to the moving unit 50 may be moved, e.g., repositioned along the x-direction.

The lifter 60 may be disposed at the moving unit 50 and may lift the blade 70 up and down along the moving unit 50 in the z-axis direction. For example, the lifter 60 may be formed as a cylinder that is disposed on the linear motor, i.e., on the moving unit 50, and may extend and retract in a predetermined direction, e.g., along the z-axis, to move the blade 70 up and down, e.g., along the z-axis.

The blade 70 may be connected to the lifter 60 and may be placed at the moving stage 20 while rotating. Therefore, the blade 70 may cut the mother substrate 2 that moves with the moving stage 20.

As illustrated in FIGS. 1 and 5, the blade 70 may be connected to a motor 71, and the motor 71 may be attached to the lifter 60. In example, as illustrated in FIGS. 1 and 5, the motor 71 and the moving unit 50 may be on perpendicular surfaces of the lifter 60. The blade 70 may be, e.g., a rotary blade at the opposite side of the moving unit 50. The blade 70 may be rotated by the operation of the motor 71. As an example, the blade 70 may be a dicing saw.

Hereinafter, an operation of cutting the mother substrate 2 using the mother substrate cutting apparatus 1 according to an exemplary embodiment will be described.

FIG. 5 illustrates a diagram of cutting a mother substrate using the mother substrate cutting apparatus of FIG. 1 and a cutting method according to the first exemplary embodiment.

Referring to FIG. 5, the mother substrate 2 may include a first protection film 201 and a second protection film 202 attached on opposite sides thereof. The first protection film 201 may be attached on the rear substrate 31, and the second protection film 202 may be attached on the front substrate 32.

The first protection film 201 and the second protection film 202 may enable a cutting operation to be smoothly performed when the mother substrate 2 is cut into stripes and then into cells. The first protection film 201 and the second protection film 202 may prevent damage by allowing the cutting of the surface of the mother substrate 2 to extend into the inside thereof. For example, as illustrated in FIG. 5, the blade 70 may rotate and cut through the mother substrate 2, e.g., through the rear substrate 31 and the front substrate 32 simultaneously between two sealants 33 at adjacent OLED displays 3.

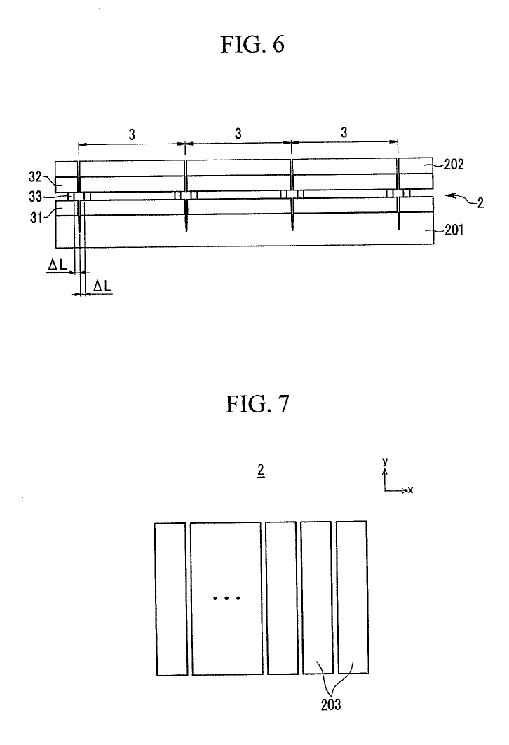

FIG. 6 illustrates a cross-sectional view of cutting the mother substrate 2 into stripes using the mother substrate cutting apparatus 1 of FIG. 1. FIG. 7 illustrates a top plan view of cuts made in the mother substrate 2, i.e., stripes, by the mother substrate cutting apparatus 1 of FIG. 1.

Referring to FIGS. 6 and 7, the mother substrate 2 may be cut into a plurality of stripes 203 through full-cutting using the blade 70. A margin (ΔL) may be formed at both ends of the OLED display 3. In this respect, it is noted that ΔL is measured as a distance between the blade 70 and a surface of the sealant 33 facing the blade 70. For example, as illustrated in FIGS. 5 and 6, the blade 70 may be positioned to cut between the two sealants 33 having a distance 2ΔL therebetween, e.g., 2ΔL being a distance between two adjacent OLEDs 3 in the mother substrate 2.

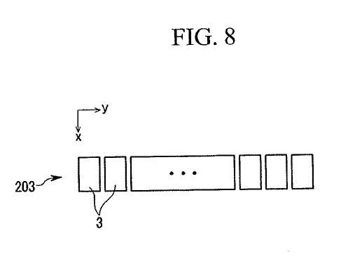

FIG. 8 illustrates a top plan view of the stripe of FIG. 7 cut into cells. Referring to FIG. 8, one stripe 203 may be cut into a plurality of cells, i.e., OLED displays 3, through full-cutting using the blade 70. For example, after the mother substrate 2 is cut into stripes via full cutting, the stripes may be rotated on the moving stage 20, so that blade 70 may cut the stripes into cells.

As described above, since the mother substrate 2 may be cut into OLED displays 3 through full-cutting, it may be possible to minimize the margin (ΔL) formed at both ends of the OLED display 3 (see FIGS. 5 and 6).

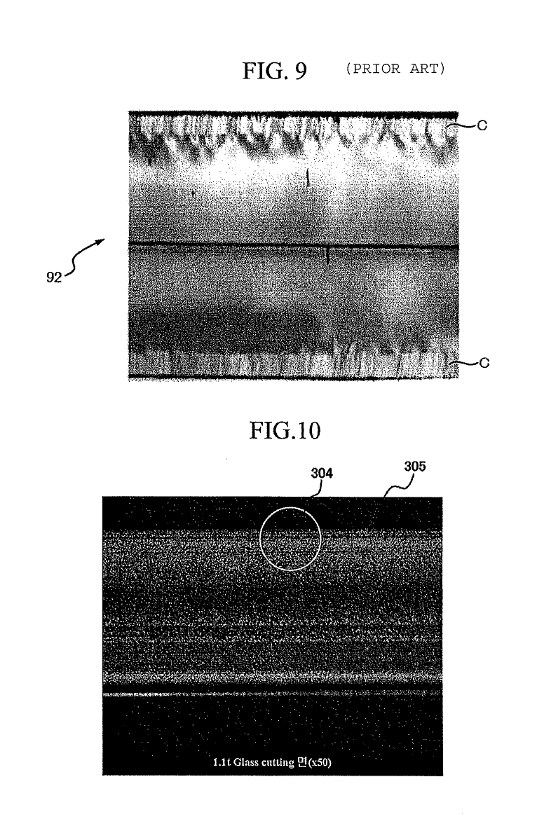

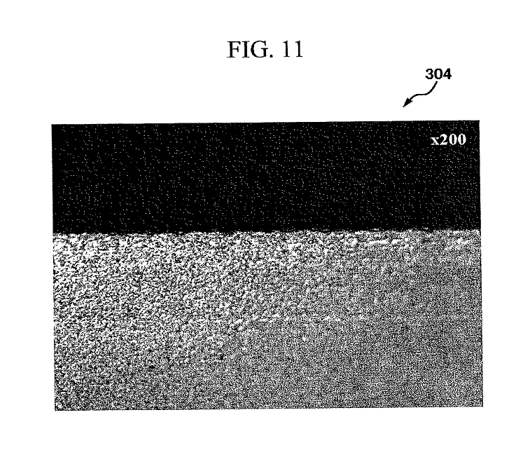

FIG. 9 is a cross-sectional view of a cut made in a mother substrate using a wheel scriber according to the comparative art. FIG. 10 is a cross-sectional view of a cut made in a mother substrate using the mother substrate cutting apparatus 1 of FIG. 1. FIG. 11 is a partial enlarged view of FIG. 10.

According to example embodiments, when the mother substrate 2 is cut by the apparatus 1, an incision surface 305 of one cell, i.e., an OLED display 3, may have a stripe pattern 304 formed by the rotary cutting operation of the blade 70. As illustrated in FIG. 10, the incision surface 305 may be substantially smooth. That is, a crack or burr may not be created at the incision surface. The incision surface may refer to a surface at the mother substrate 2 or OLED display 3 in the yz plane contacted by the blade 70, and the stripe pattern may refer to cuts through the mother substrate 2, e.g., cuts illustrated in FIG. 6 and separating the mother substrate 2 into individual OLED display 3.

In contrast, as illustrated in FIG. 9, when a wheel scriber is used to cut a mother substrate 92, cracks (c) on both sides of the mother substrate 92 may be formed. That is, the incision surface of a mother substrate cut by the wheel scriber may not be smooth, e.g., may exhibit a relatively high surface roughness with irregular and coarse portions. Accordingly, a mother substrate cut by an apparatus according to an exemplary embodiment may have a high quality of incision surface, e.g., no cracks or coarse portions.

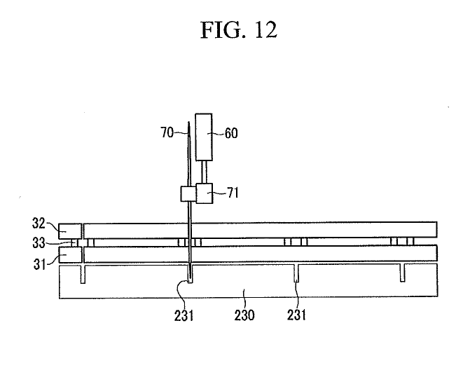

FIG. 12 illustrates a diagram of cutting the mother substrate 2 using a mother substrate cutting apparatus and a cutting method according to another exemplary embodiment of the present invention.

Referring to FIG. 12, the moving stage 20 may further include an absorptive jig 230. Therefore, the absorptive jig 230 may absorb and support the mother substrate 2. The absorptive jig 230 may be positioned under the substrate 31.

The absorptive jig 230 may include a groove 231 to receive the blade 70 corresponding to a cutting location. The groove 231 may enable the mother substrate 2 to be cut, e.g., completely cut, by allowing the insertion of the blade 70 to move forward while cutting the mother substrate 2. For example, during a cutting operation, the blade 70 may cut through the mother substrate 2, so an edge of the blade 70 may fit into the groove 231.

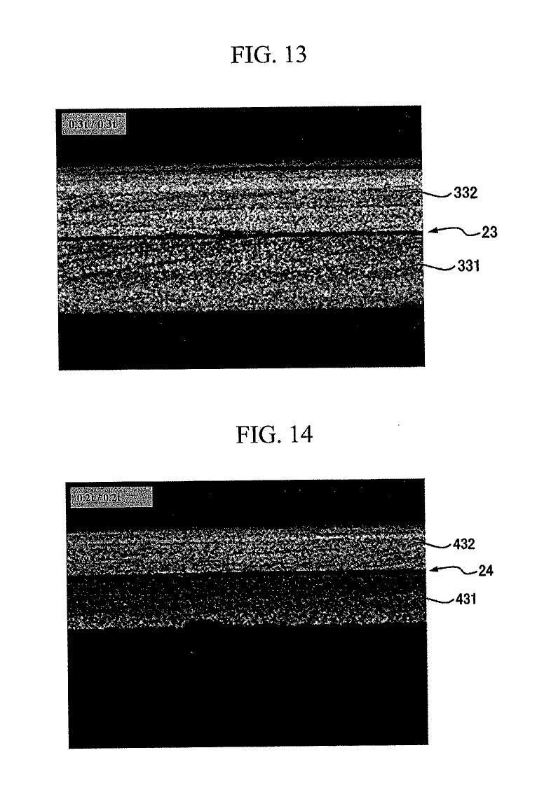

FIGS. 13 to 15 are cross-sectional views of cuts made on various mother substrates having different thicknesses. Referring to FIGS. 13 to 15, the cuts on respective mother substrates 23, 24, and 25 are illustrated as examples.

Each rear substrate 331 and front substrate 332 has a thickness of about 0.125 mm in the mother substrate 23 of FIG. 13. It is impossible to use a wheel scriber according to comparative art to cut the mother substrate 23 having the rear substrate 331 and the front substrate 332 because the mother substrate 23 is too thin.

In the mother substrate 24 of FIG. 14, each rear substrate 431 and front substrate 432 has a thickness of about 0.2 mm. It is impossible to use a wheel scriber according to the comparative art to cut the mother substrate 24 having the rear and front substrates 431 and 432 because the mother substrate 24 is too thin.

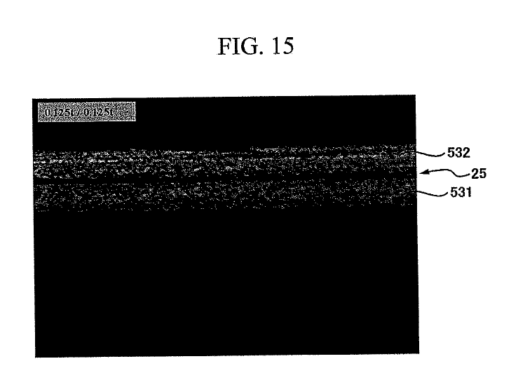

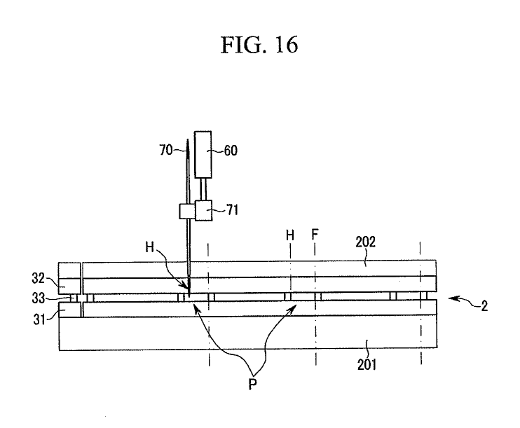

In the mother substrate 25 of FIG. 15, each rear substrate 531 and front substrate 532 has a thickness of about 0.3 mm. It may be hard to use a wheel scriber to cut the mother substrate 25 having the rear and front substrates 531 and 532. For example, as illustrated in FIG. 9, attempts to use a wheel scriber in the mother substrate 25 may result in a coarse incision surface with cracks (c), so the quality of the incision surface thereof may be deteriorated as compared to the present exemplary embodiment.

The mother substrate cutting apparatus 1 according to an exemplary embodiment may cut the thin, e.g., ultra slim, mother substrates 23, 24, and 25 through full-cutting, and the quality of the incision surface thereof may be improved as the thickness becomes thinner.

FIG. 16 illustrates a cross-sectional view of a mother substrate undergoing a half-cutting using the mother substrate cutting apparatus 1 of the present embodiment. Referring to FIG. 16, the blade 70 may cut the front substrate 32 without cutting the rear substrate 31 in the mother substrate 2 to form a pad unit P at the rear substrate 31. That is, the mother substrate 2 may be cut through half-cutting (H). In this respect, it is noted that half-cutting (H) refers to cutting only the front substrate 32 in one step without cutting the rear substrate 31, and full-cutting (F) refers to cutting both front and rear substrates 31 and 32 in one step.

After half-cutting (H) the mother substrate 2 by only cutting the front substrate 32, both of the rear substrate 31 and the front substrate 32 may be cut through full-cutting (F). For example, the full-cutting (F) may be applied to cut the mother substrate 2 into stripes 203 (as illustrated in FIG. 7), and the half-cutting (H) may be applied for cutting the stripes 203 into cells, i.e., OLED displays 3.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1.-13. (canceled)

14. A method of cutting a mother substrate, the method comprising:
positioning the mother substrate on a moving stage of a stationary stage;
positioning a blade at a cutting position above the mother substrate through controlling a moving unit disposed at a guide bar and a lifter disposed at the moving unit, the blade contacting the mother substrate; and
moving the moving stage in a first direction and rotating the blade to cut the mother substrate.

15. The method of cutting a mother substrate as claimed in claim 14, wherein rotating the blade to cut the mother substrate includes:
cutting the mother substrate into stripes; and
cutting the stripes into cells.

16. The method of cutting a mother substrate as claimed in claim 15, wherein the stripes are cut using a full-cutting and cells are cut using a half-cutting.

17. The method of cutting a mother substrate as claimed in claim 15, wherein both stripes are cells are cut via full-cutting.

18. The method of cutting a mother substrate as claimed in claim 15, wherein the cutting into stripes includes repeatedly driving the moving unit, the lifter and the moving stage.

19. The method of cutting a mother substrate as claimed in claim 14, wherein rotating the blade to cut the mother substrate includes cutting an incision surface of the mother substrate into a stripe pattern by rotary operation of the blade, such that a cell is defined between at least two stripes.

20. The method of cutting a mother substrate as claimed in claim 19, wherein the cell forms an organic light emitting diode (OLED) display.
